(19) United States
(12) Patent Application Publication
(10) Pub. No.: US 2022/0207135 A1
(43) Pub. Date: Jun. 30, 2022

(54) SYSTEM AND METHOD FOR MONITORING, MEASURING, AND MITIGATING CYBER THREATS TO A COMPUTER SYSTEM

(71) Applicant: KPMG LLP, New York, NY (US)

(72) Inventors: Vijay JAJOO, Fremont, CA (US); Sreekar KRISHNA, Phoenix, AZ (US); Yiwen ZHANG, New York, NY (US); Anthony Lanting GAWRON, Chicago, IL (US)

(21) Appl. No.: 17/493,138

(22) Filed: Oct. 4, 2021

Related U.S. Application Data
(63) Continuation of application No. 17/034,788, filed on Sep. 28, 2020, now abandoned.

(51) Int. Cl. G06F 21/55; G06N 20/00; G06F 21/60

(52) U.S. Cl. CPC G06F 21/55; G06F 21/60; G06N 20/00

(57) ABSTRACT

A cyber security system employing machine learning techniques to help predict and protect computing systems from cyber-attacks. The system comprises data sources for storing security data, a deployment infrastructure for generating a portion of the security data insights, and a data analytics module for processing the security data. The data analytics module includes a data connector unit for collecting and organizing the security data into a selected format, a data preprocessing unit for cleaning the organized security data, a cyber feature unit for identifying based on preselected cyber features selected portions of the cleaned security data associated with the cyber features, a model development unit for applying one or more selected machine learning techniques to the features to form output model data, and a model prediction unit for generating based on the output model data one or more prediction values based on the cleaned security data and the cyber features.

### RELATED APPLICATION

The present application is a continuation of U.S. patent application Ser. No. 17/034,788, entitled SYSTEM AND METHOD FOR MONITORING, MEASURING, AND MITIGATING CYBER THREATS TO A COMPUTER SYSTEM, filed on Sep. 28, 2020, the contents of which are herein incorporated by reference.

### BACKGROUND OF THE INVENTION

The present invention is generally related to cyber security threats to enterprise and personal computer systems, and more particularly relates to systems and methods for monitoring and mitigating cyber security threats and cyber risks to corporate and employee computer systems.

With the ever increasing levels of personal and corporate dependence on Information Technology (IT) systems and their ubiquitous interconnection to the Internet, there has unfortunately been a significant rise in the amount and range of malicious attacks (cyber threats or cyber-attacks) by hackers or the like, operating in ‘cyber space,’ to attack or undermine the operations of the IT systems. That is, cyber-attacks are more frequent than ever before due to the ever increasing availability of internet connectivity across all types of devices from laptops, desktops, notepads, mobile phones and the broad spectrum of everyday devices that are connected to the Internet (e.g., Internet-of-Things or IoT) and are significantly affecting businesses and individual's productivity and monetary interests. The cyber-attacks normally target vulnerabilities in the IT systems to steal confidential information, and can take many forms including Phishing attacks, distributed denial-of-service attacks, account takeover attempts, ransomware attacks, and other known malicious types of activity, and have come to dominate the everyday operations of organizations, thereby requiring significant labor force and enterprise attention and resources. Additionally, the cyber-attacks can target individual employees through sophisticated social engineering personalized attacks. These collectively have become known as cyber-crimes.

Cyber-crimes have become one of the world's major problems with new breaches of data and releases of ransomware occurring hourly at an alarming rate. Cyber-crimes cost many businesses billions of dollars every year. Any person or business regardless of size is potentially vulnerable to cyber risks, from some of the world's largest corporations, to critical national infrastructure, to small local enterprises, and to individuals. These types of cyber-crimes will continue to increase, particularly as evolving programs such as Internet of Things (IoT), smart cities, and mass digitization become the reality of daily life. Further, the cost of preventing and responding to cyber-crimes will continue to grow exponentially causing serious financial and reputational damage to individuals and businesses.

In order to properly address these cyber security threats, a significant cyber security infrastructure and related personnel needs to be deployed and maintained. The security infrastructure can include employing a number of different security tool software applications as well as associated hardware devices, all maintained by the technical personnel. As the cyber threats increase in size and scale, and become more sophisticated, businesses and the employees who manage the security infrastructure have needed to adapt. This adaptation requires new skills, new tools, new processes, policies and enterprise-level training.

Currently, cybersecurity solutions rely on tedious human labor centered around a diverse combination of point solutions (to cyber threat management) with limited knowledge sharing between competitive data silos, networks, and associated security vendors. Even within businesses, data related to different types of cyber-threats is often siloed and not shared across the security infrastructure platform. Cyber criminals can hence capitalize on static controls set on siloed data sources that still define the security landscape for many businesses. As such, the information security teams are often slow to respond to real time cyber-attacks on the system since they are not being provided with critical cyber-attack data across the entire system in real time. In an effort to keep businesses secure, the information security teams spend a large amount of resources fine tuning the static security rules. The teams also tend to set conservative risk thresholds in an effort to timely identify system attacks, which can unfortunately lead to a large amount of false alarms. Both of these activities are time consuming, costly, and hard to scale across the platform. Still further, the volume of cyber tools and log data generated by the system also makes it difficult to detect attacks because of the difficulties experienced processing the large amounts of data and then identifying attack data therefrom. To further complicate matters, the industry as a whole is struggling with a scarcity of trained cyber specialists. As a result, most companies are still highly vulnerable to cyber threats due to the constantly changing nature of cyber-attacks, the siloed nature of the security data, and lack of trained personnel.

In light of the current cyber security risks, there is an imminent need for a cyber security solution that aggregates security data across the platform and enables adaptive and proactive capabilities for identifying new cyber threats and allowing end users to reduce, mitigate, or eliminate them. The need extends from just being a point solution to really enabling each business to address their own individual risk profile by fundamentally enabling scale and reducing dependence on humans as the connection between point solutions. The core enablers for such a solution can thus provide businesses with the data insight and infrastructure to accurately identify, measure, quantify, and respond to the cyber risks and threats to which the business is exposed.

### SUMMARY OF THE INVENTION

In light of the above-mentioned needs, the present invention is directed to a cyber security threat management system that employs a unique and fully scalable Artificial Intelligence (AI) based analytical tool for adaptive, intuitive, automated, and seamless review of security data, thereby giving cybersecurity teams the ability to monitor, identify, remediate, mitigate and resolve cyber security issues at scale. The system and method of the present invention assists businesses with transforming their cyber security infrastructure into a robust, integrated security platform that employs artificial intelligence and machine learning.

The cyber security monitoring and mitigation system of the present invention employs an analytics module that processes security data so as to generate and determine cyber security risks and generate predictions based on the processing of the security data. The analytics module can employ a data connector unit for retrieving selected security data based on preselected cyber features. The data from the data connector unit is then preprocessed by profiling and cleaning the data and generating cleaned security data that is disposed in a structured format. The consistence of the structured data format allows the system to quickly and efficiently process the data to analyze and identify real time cyber security risks and needs. The cleaned security data then has one or more cyber feature elements overlaid thereon to extract and identify selected security data for processing by one or more machine learning techniques. The machine learning techniques helps identify selected portions of the security data based on the cyber feature elements for processing by the prediction unit. The prediction unit then generates prediction or probability values or information based on the security data and the cyber features. The system can respond to the predictions by addressing, reducing and eliminating cyber security threats and issues. The prediction information can be subsequently processed by a data visualization unit for generating one or more user interfaces that displays selected types of information to the system user. The present invention thus helps businesses address and reduce the occurrence of cyber security threats and attacks by leveraging the power of AI and machine learning enabled technologies. As such, once the system and method of the present invention is adopted, the information technology infrastructure of the underlying business can be transformed from a conventional reactive siloed system to a proactive system that monitors, measures, and mitigates in real time cyber threats and risks.

The present invention is directed to a cyber security monitoring and mitigation system comprising one or more data sources for storing security data, a deployment infrastructure subsystem having a security tool layer for generating at least a portion of the security data and one or more storage elements for storing at least a portion of the security data, and a data analytics module for processing the security data. The analytics module includes a data connector unit for collecting the security data from one or more of the data sources and then organizing the security data into a selected format to form organized security data, a data preprocessing unit for profiling and correcting the organized security data to form cleaned security data, a cyber feature unit for identifying based on preselected cyber features selected portions of the cleaned security data associated with the cyber features, a model development unit for applying one or more selected machine learning techniques to the features from the cyber feature unit to form output model data, and a model prediction unit for generating based on the output model data one or more prediction values based on the cleaned security data and the cyber features.

The system further includes a results integrator unit for generating from the prediction values one or more user interfaces for displaying the prediction values, a network for communicating with the one or more of the one or more data sources, the data analytics module, and the deployment infrastructure, and for communicating the security data therebetween, and a data merger unit for merging cleaned security data from two or more of the plurality of data sources. The system can also include a data search engine communicating with the data connector unit and the security data for searching the security data for one or more selected parameters.

According to the present invention, the data preprocessing unit comprises a data profiler unit that is configured to analyze and to process the organized security data in a data frame received from the data connector unit and summarize one or more values associated with the organized security data contained in the data frame to form profiled security data, and a data cleaner unit for detecting and correcting selected information in the profiled security data within the data frame to form the cleaned security data. The one or more values associated with the organized data comprises selected numerical fields, timestamp information, categorical field information, information related to changes in the security data, and historical trend information. The data cleaner unit comprises a cleaning schema module for applying a uniform cleaning schema to the profiled security data, and the cyber feature unit comprises a plurality of selectable cyber features.

According to one practice, the machine learning technique of the model deployment unit comprises one or more of a supervised machine learning technique, an unsupervised machine learning technique, a semi-supervised learning technique, a self-learning technique, or a reinforcement machine learning technique.

The present invention is also directed to a computer implemented method comprising providing security data from one or more data sources, generating at least a portion of the security data and storing at least a portion of the security data in one or more storage elements, and processing the security data. The security data can be processed by collecting the security data from one or more of the data sources and then organizing the security data into a selected format to form organized security data, profiling and correcting the organized security data to form cleaned security data, identifying based on one or more preselected cyber features selected portions of the cleaned security data associated with the cyber features, applying one or more selected machine learning techniques to the cleaned security data to form output model data, generating based on the output model data one or more prediction values based on the cleaned security data and the cyber features, and generating from the prediction values one or more user interfaces for displaying the prediction values.

The computer-implemented method of the present invention also includes merging cleaned security data from two or more of the data sources, and providing a data search engine for searching the security data for one or more selected parameters. Further, the step of collecting the security data comprises generating a data frame that includes therein the organized security data, and the step of profiling and correcting the organized security data further comprises analyzing and processing the organized security data in the data frame and summarizing one or more values associated with the organized security data contained in the data frame to form profiled security data, and detecting and correcting selected information in the profiled security data within the data frame to form the cleaned security data.

### BRIEF DESCRIPTION OF THE DRAWINGS

These and other features and advantages of the present invention will be more fully understood by reference to the following detailed description in conjunction with the attached drawings in which like reference numerals refer to like elements throughout the different views. The drawings illustrate principals of the invention and, although not to scale, show relative dimensions.

FIG. 1 is a schematic block diagram of the cyber security monitoring and mitigation system of the present invention.

FIG. 2 is an example embodiment of the cyber security monitoring and mitigation system of FIG. 1.

FIG. 3 is a schematic block diagram illustrating the operation and function of the data connector unit of the cyber security monitoring and mitigation system of the present invention.

FIG. 4 is a schematic block diagram illustrating the operation and function of the data cleaner unit of the cyber security monitoring and mitigation system of the present invention.

FIG. 5 is a representation of a user interface generated by the cyber security monitoring and mitigation system of the present invention.

FIG. 6 is a representation of another user interface generated by the cyber security monitoring and mitigation system of the present invention.

FIG. 7 is a representation of yet another user interface generated by the cyber security monitoring and mitigation system of the present invention.

FIG. 8 is a high-level block diagram schematic depiction of an electronic device that can be used with the cyber security monitoring and mitigation system of the present invention.

### DETAILED DESCRIPTION

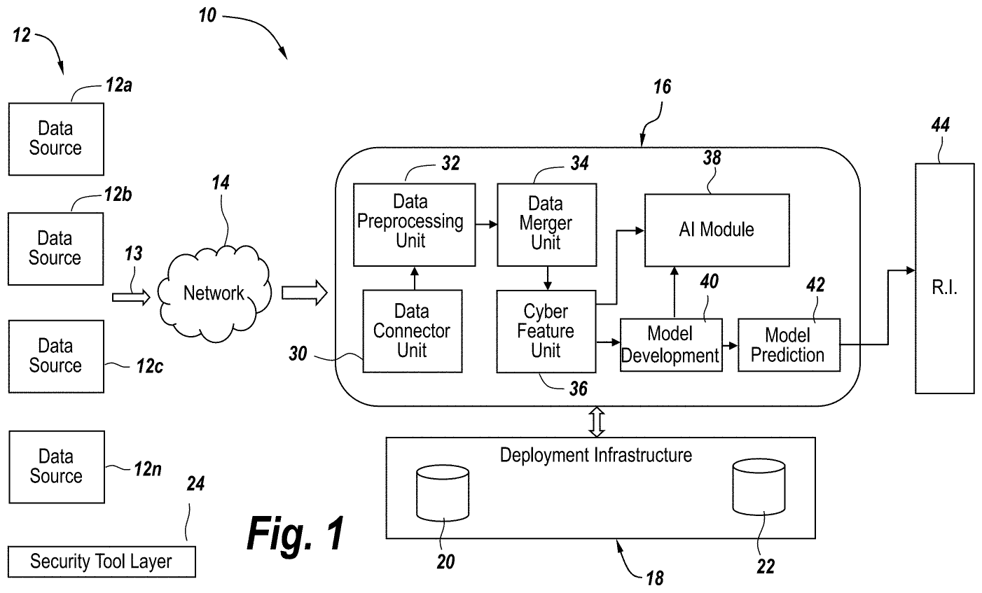

The present invention is directed to a cyber security monitoring and mitigation system 10 that help organizations, such as enterprise businesses, protect their critical IT infrastructure and associated data from cyber criminals. A simplified schematic representation of the cyber security monitoring and mitigation system 10 of the present invention is shown in FIG. 1. The system 10 includes a plurality of data sources 12, including for example data sources 12a-12n, for providing various types of security data 13 to the system for further processing and analysis. As used herein, the term “security data” is intended to include any type of data, including structured and unstructured data, associated with one or more parameters or characteristics of one or more security features, security tools, or users of a computer system. The security data can be data or information that is generated by or associated with one or more security software applications employed by the system, one or more hardware devices employed by the system, or one or more users of the system. Examples of the types of information or data employed or generated by the system and encompassed by the security data, without limitation, include user login information, user identification information, user login frequency information, time between successive user logins, geographic location of the user, time between changes in geographic location of a user, internet address information (e.g., IP address data) associated with the user, information associated with firmware, malware, or ransomware, potentially malicious executable files, corrupted or non-corrupted system hardware or software, any data that is collected by the existing security toolchain that adds to the explicit data collected by the enterprise itself, data associated with traffic volume on a selected network, domain information, information associated with potential patterns of login activity, changes or variability in login behavior, website traffic data, any patterns of data access by employees, vendors, contractors or customers of the enterprise, any data collected from internal websites and portal visited by their employee, vendors, contractors and others, known risk or key indicators, information associated with user session times or session history on the network, cryptographic information, firewall information, antivirus software information, security token information (e.g., cryptographic keys, digital signatures, biometric data, and passwords), data masking information, data erasure information, any third party data that is bought by the enterprise institution to augment their own security data (e.g., externally available identity data of their employees, vendors, contractors and customers, socio-geographic data of their employees, vendors, contractors and customers, externally collected web traffic data around), and the like. Those of ordinary skill in the art will readily recognize that the foregoing list is not exhaustive and that security data can include data from other sources.

The security data 13 from the data sources 12 can be conveyed or transferred to other portions of the cyber security monitoring and mitigation system 10 via wired connections or wireless connections, such as via a network 14. The security data 13 is eventually transferred to a data analytics module 16 that communicates with a deployment infrastructure subsystem 18. The illustrated deployment infrastructure subsystem 18 can include any selected number or collection of computer infrastructure components, including both hardware and software, that are constructed and configured to develop, test, monitor, control, support or deliver selected information technology services. The deployment infrastructure subsystem can be housed or located at a single location or can be distributed across an on-premises IT platform, and can include if desired any selected type and number of cloud hosting services. The deployment infrastructure subsystem 18 can include, for example, one or more client devices, one or more servers, such as for example Linux servers, Windows servers, Cloud Operating System servers, docker and Kubernetes servers, one or more types of data engines, one or more cluster type frameworks, such as a Spark cluster, and one or more types of containerization software applications, as well as other known hardware and software components. The deployment infrastructure subsystem 18 can also include client data sources and computer clusters, server networks and farms, and the like. The system 10 can also include a security tool layer 24 that includes a plurality of known types of security tools for monitoring and maintaining the security of the network. The security data 13 can be generated by the security tools in the security tool layer 24 or from other security tools in associated networks or a combination of both. The data sources 12 can thus reside within or form part of the security tool layer 24, can be external to the security tool layer 24, or can be a combination of both. The deployment infrastructure subsystem 18 can also include electronic or computer devices, such as servers and clients, having known processing capabilities, as well as selected and varied types of storage and memory associated therewith, indicated in a simplified manner as storage elements 20 and 22. The illustrated storage elements 20, 22 are represented as a database for the sake of simplicity.

The deployment infrastructure subsystem 18 communicates via known communication technology with the data analytics module 16. The illustrated data analytics module 16 can include selected types of data preprocessing and processing subsystems or units and associated functionality, as well as include selected types of artificial intelligence and machine learning capabilities. For example, and according to one embodiment, the illustrated data analytics module 16 can include a data connector unit 30 for collecting selected types of data, including security data, from the data sources 12a-12n and then organizing the data into a selected type or format. The organized security data generated or produced by the data connector unit 30 is then conveyed to a data preprocessing unit 32. The data preprocessing unit 32 can be employed to profile and clean the security data for subsequent use by the system. Specifically, the data profiler can be configured to summarize selected values or statistics associated with the data. Further, the data preprocessing unit 32 can also clean the data by comparing the security data to a selected cleaning schema so as to generate or create a common data types or data structure, such as a data frame. The preprocessed security data from the various data sources can then be merged by an optional data merger unit 34. The merged security data is then introduced or conveyed to other elements or portions of the data analytics module 16.

According to one embodiment of the present invention, the data analytics module 16 can include a cyber feature unit 36 for selecting one or more, and preferably a plurality, of cyber features for processing by the module 16. The cyber features can include a list or table of selected types or attributes of security data that can be preselected by the system user and overlaid on the cleaned data frame so as to identify selected portions of the security data. The extracted security data is then introduced to the AI training module 38 for further processing and for training any selected machine learning component associated therewith. The AI module can include and employ one or more known machine learning model training components or techniques and the like.

The illustrated data analytics module 16 can further include a model development unit 40 and a model prediction unit 42. The model development unit 40 develops and deploys or applies a machine learning model for processing the curated and extracted security data and associated information and the model prediction unit 42 forms or generates predictions based on the machine learning techniques as applied to the extracted security data. The model deployment unit can employ any selected known type of machine learning technique, including for example one or more of, or any combination of, a neural network technique, a Random Forest technique, an XGBoost technique, one or more known methods or techniques for explaining predictions, such as for example a Shapely Additive Explanation (SHAP) technique, and the like.

The security data and associated predictions can then be introduced or conveyed to a results integrator unit 44 for integrating the data results into a useable format by the system and for displaying the results to an end user. The results integrator unit 44 can employ one or more known report generators, data visualization software applications, and/or one or more known user interface units for generating one or more user interfaces. The reports generator and/or the user interface unit can also be deployed separately from the results integrator unit 44.

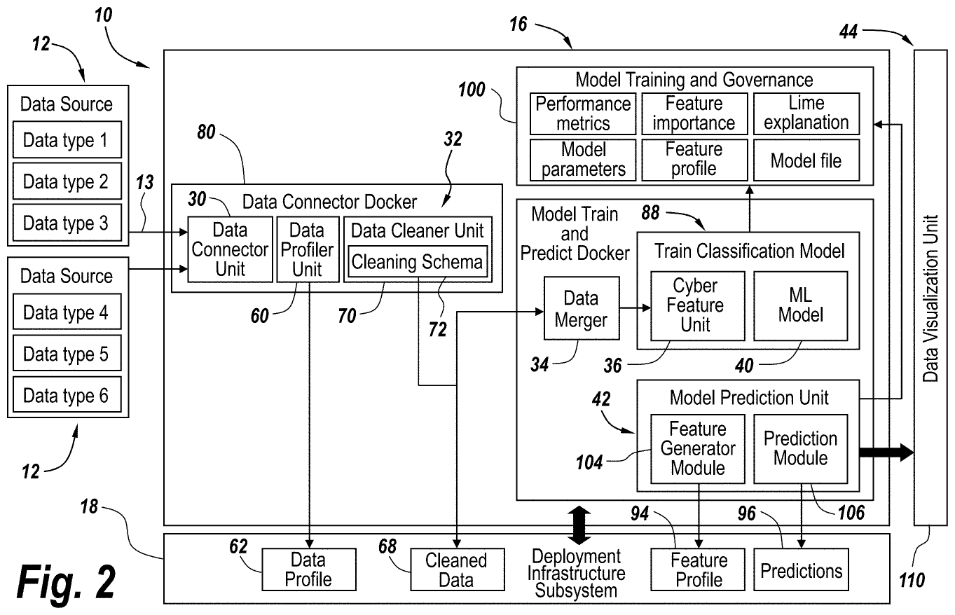

Further details of the cyber security monitoring and mitigation system 10 of the present invention is shown in FIG. 2. The illustrated data sources 12 provide multiple different types of security data 13 to the data analytics module 16, which are for purposes of simplicity, illustrated as Data Types 1-n. One of ordinary skill in the art will readily recognize that the data sources 12 can include and provide security data 13 of many different types, and can provide any selected number of security data types to the data analytics module 16. The types of security data supplied or provided to the data analytics module 16 by the data sources 12 can be pre-selected by the system manager based on client and system need, and preferably correspond to one or more of the feature elements of the cyber feature unit 36 or to the data generated by one or more of the security tools in the deployment infrastructure.

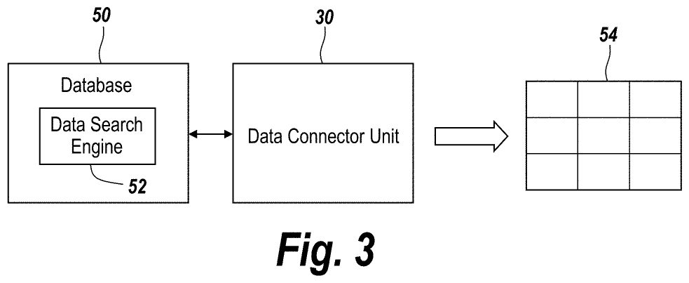

The security data 13 is initially supplied to the data connector unit 30 as part of a data ingestion methodology employed by the data analytics module 16. As shown in FIG. 3, the data connector 30 can communicate with a storage element, such as database 50. The database can be any selected data storage element and can be located at any selected location either within the cyber security monitoring and mitigation system 10 or external thereto. For example, the database 50 can correspond according to one embodiment to either of the storage elements 20, 22 of the deployment infrastructure subsystem 18. The database 50 is configured to store the security data, and either the database or the data connector unit 30 can include a data search engine 52 for searching the security data that is stored therein. The data search engine 52 can be any selected known type of data search engine, such as the search engine software application Splunk by Splunk Inc or the Elasticsearch search engine by Elastic Nev. The data connector 30 can pull or search one or more selected types of security data within the database 50 according to any selected known parameter or data field, such as for example by searching the database URL, authentication parameters, data field filters and the like. The data connector 30 can then parse the data and then generate in turn structured data, such as for example any suitable data structure, including the data frame 54. Examples of suitable data frames are data frames generated by the Pandas library and Spark type data frames. The data frames provide a uniform and organized structure to the data pulled from the database 50 by the data connector unit 30. As shown, the data frame 54 can have any suitable structure and arrangement, and preferably has a two-dimensional structure having both columns and rows.

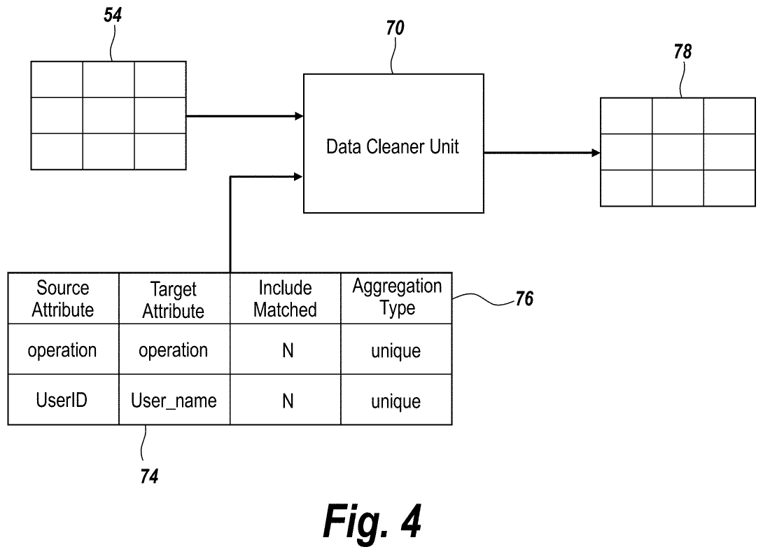

The data preprocessing unit 32 of FIG. 1 is represented by the data profiler unit 60 and the data cleaner unit 70, as shown in FIGS. 2 and 4. The data profiler unit 60 is configured to analyze and process the organized security data in the data frame 54 received from the data connector unit 30. The data profiler unit 60 analyzes the organized security data in the data frame and summarizes the basic values or attributes of the security data contained in the data frame 54. Specifically, the data profiler unit 60 summarizes the data by extracting the statistics associated with the security data, including parameters such as minimum (min), maximum (max), mean, median, mode, and quantile information (e.g., first, second, and third quantile), kurtosis, skewness, randomness in the model, entropy, start time, end time, click and dwell duration, hash values for text fields, distinct count, unique values, rare values, nulls, and the like. The values in the data frame 54 can correspond to selected numerical fields (e.g., min values, max values, quantile data, mean, standard deviation information, binned frequency and the like), timestamp information (e.g., start time, end time, and duration), categorical field information (e.g., the number of distinct categories, the frequency of categories, and the like), and information related to changes in the data (e.g., changes in distribution such as divergence values, new values added, and the like), as well as historical trend information. The data profiler unit 60 analyzes and summarizes each attribute of the data and any unique values associated therewith. The profiler thus functions as the translator between the raw organized security data and numerically recognizable attributes of the data that the algorithms can meaningfully use for interpretation later in the system. The different attributes that the profiler extracts from the data can be preconfigured or coded into the system so future enhancements to the profiler are relatively easy and straight forward. The profiled security data 62 can be separately stored if desired in one or more storage units, such as the storage unit 20, 22 of the deployment infrastructure subsystem 18, for subsequent use by the system 10.

The data cleaner unit 70 is configured to clean the profiled security data received from the data profiler unit 60 by detecting and correcting inaccurate or incomplete data within the data frame according to known techniques to form cleaned security data. The data cleaner unit 70 thus ensures that the data is accurate, valid, correct, complete, consistent, and uniform (e.g., cleaned). The data cleaner unit 70 can include a cleaning schema module 72 for cleaning the data by applying a uniform cleaning schema or process to the profiled security data. For example, as shown in FIG. 4, the data frame 54 from the data collector unit 30 and the data profiler unit 60 is input into the data cleaner unit 70. The data cleaner unit 70 can include a cleaning schema module 72 for applying a preselected cleaning schema 74 to the data frame 54. The cleaning schema 74 can be a preselected two dimensional data structure, such as a table, that is employed to process and clean the data in the data frame 54 by checking to ensure that the data frame 54 has the correct number and type of columns, and that the data or values in each row is correct. The cleaning of the data frame 54 can include renaming columns, clean or correct incorrect IP addresses, and the like. The data cleaner unit 70 thus generates a cleaned data frame 78 that corresponds to the input data frame 54. An example of a suitable cleaning schema 74 is shown in FIG. 4. The cleaning schema 74 can be a table having a selected number of rows and columns, with data therein in selected data fields 76. The cleaning schema may include any suitable software application that is capable of interpolating any missing values in the data in the data frame 54 by using one of many known methods for surmising missing data values based on the relative closeness of other values of possible data. While the cleaning methodology may vary depending on the type of data, a selection of all of the commonly available types maybe present as a configurable option for the users of the cyber security system to choose from. The software associated with the data connector unit 30, the data profiler unit 60, and the data cleaner unit 70 can preferably be placed in a software docker or container 80. The cleaned security data 68 can be separately stored if desired in one or more storage units, such as the storage unit 20, 22 of the deployment infrastructure subsystem 18, for subsequent use by the system 10.

The security data from each of the data sources 12 is processed by the data connector unit 30, the data profiler unit 60, and the data cleaner unit 70 in the container unit 80, and the resultant cleaned data frames 78 are merged in the data merger unit 34 with other cleaned data frames that are processed by the system and that are received from other data sources 12. The data merger unit 34 ensures that all of the data sources are combined or merged in a standardized manner so that all numerical data can be accessed in the same way irrespective of the original source of data. The merger unit 34 also ensures that the data sources 12 are correctly identified (e.g., tagged) to the right data sets so remediation and auditing of the data sources can be easily done. Along with the raw security data from the data sources 12, the merger unit 34 can also normalize (e.g., make the baseline representation of each data set equal) the data sets so that similar attributes of cyber information between different cyber systems are treated in the same manner by the system 10.

The merged security data is then conveyed from the data merger unit 34 to the cyber feature unit 36. The cyber feature unit 36 converts the data in the merged security data and originating from the various cyber data sources into a set of features that can be used by one or more of the artificial intelligence and machine learning algorithms. More specifically, features that are generated or outputted by the cyber feature unit, as that term is used herein, can include a defined table of outputs, which may be numerals, category variables, or binary variables, and the like. The cyber features allow the system to interpret the security data that may have originated from various and different locations and systems in a common way. The cyber feature unit 36 also functions as a way for the users of the system to transfer human learned knowledge of how cyber attackers act into a meaningful numerical, or machine interpretable, score or value to be used for all use cases that can be integrated with the overall system. The features generated by the cyber feature unit 36 can be considered as the cyber knowledge repository for any institution that implements the present invention. All the features generated as part of the daily operation of the present invention are retained by the system and hence act as a central storage of all the features that are used by cyber analysts within the organization to do their daily cyber remediation activities.

The cyber feature unit 36 can include or communicate with a feature generator module 104 that includes a plurality of different cyber features or characteristics that the system can review, analysis and evaluate. The feature generator module 104 can be located in the cyber feature unit 36, or at other locations in the system 10, such as for example by forming part of the model prediction unit 42. The feature generator module 104 can generate cyber feature profile data 94 that can be stored in the system, such as for example in the deployment infrastructure subsystem 18. According to the present invention, the cyber features can include without limitation rate or volume of cyber events, network traffic volume (e.g., number of log-in events and connections), changes in geo-location, time span between changes in geo-location, changes in connection or log-in behavior, whether information associated with log-in or user is previously identified as suspicious, log-in frequency, time span between log-ins, and the like. Thus, the cyber features correspond if desired to the cyber characteristics of the system 10 that the client wishes to monitor or investigate. Further, the cyber features can be preselected based on client needs, and can be aligned to the datasets that users already have stored. Thus, the cyber feature unit 36 or the feature generator module 104 can comprise if desired a plurality of selectable cyber features. As a simple example, if a user is noted to log into the system from different geographic locations, the system can determine if it is feasible that the user can manage to travel between the locations in the allotted period of time based on preselected cyber features, such as a geolocation cyber feature, time span cyber feature, and reasonable time and distance between geolocations cyber feature. If not, then the security data is marked as suspicious.

The model development unit 40 then applies one or more selected machine learning techniques to the cyber features extracted from the merged security data in order to assess and code into machine language what cyber features help distinguish everyday ‘normal’ security or cyber data from threat actor based cyber data. The machine learning techniques are commonly available methodologies (e.g., computer science algorithms) that have been proven to work with large volumes of cyber data and are able to capture and identify intricate or detailed patterns in the data. The present invention can optionally allow the users to preselect the machine learning methodology applied to the data prior to application of the data. The machine learning techniques can be a supervised learning technique (e.g., regression or classified techniques), an unsupervised learning technique (e.g., mining techniques, clustering techniques, and recommendation system techniques), a semi-supervised technique, a self-learning technique, or a reinforcement learning technique. Examples of suitable machine language techniques include Random Forest, neural network, clustering, XGBoost, bootstrap XGBoost, Deep learning Neural Nets, Decision Trees, regression Trees, and the like. The machine learning algorithms may also extend from the use of a single algorithm to the use of a combination of algorithms (e.g., ensemble methodology), and may use some of the existing methods of boosting the algorithmic learning, bagging of results to enhance learning, incorporate stochastic and deterministic approaches, and the like to ensure that the machine learning is comprehensive and complete. As such, the machine learning technique that is employed by the model development unit 40 essentially maps one or more of the input values of the extracted security data to one or more outputs or determines inferences, patterns or classifications between the security data and the cyber features based on the extracted security data and responds accordingly. The output of the model development unit 40 is cyber or output model data in the form for example of a computer model that has a well-defined interpretation and can be interpreted and run by commonly available computer code libraries. Further, the model development unit 40 may also incorporate a series of methodologies (e.g., computer algorithms) that allow the models to also output what cyber data features were of highest importance to the decision making while connecting input data with the desired output inference. Methods like local interpretable model-agnostic explanation (LIME), shapely additive explanation (SHAP), may be used to accomplish the importance mapping. The steps taken by the model development unit 40 are sometimes referred to as the machine learning training step and this step represents the encoding of institutional cyber knowledge (in the form of cyber data features and cyber incident labels for the cyber data) into well-defined computer methodologies.

The model prediction unit 42 can be used to repeatedly label or tag the cyber data generated by the model development unit 40. The model prediction unit 42 then generates one or more inference outputs or prediction data, which may correlate to what humans may have labeled the data, if they were present in place of the model, in the form of prediction or probability values and associated information as well as feature profiles 94 and predictions 96, from a prediction module 106, based on the output model data of the model development unit 40, the cyber features generated by the cyber feature unit 36, and the trained machine learning techniques. The prediction information can be in any selected form or format, and can include a prediction or probability score. The cyber security unit 36 and the model deployment (ML model) unit 42 can form part of the same software container, such as the Train Classification Docker 88. Further, the train classification docker 88, the model prediction unit 42 and the data merger unit 34 can form part of a common software container, such as the Model Train and Predict Docker 90. The feature profile data 94 and the prediction value data 96 can be separately stored if desired in one or more storage units, such as the storage unit 20, 22 of the deployment infrastructure subsystem 18, for subsequent use by the system 10.

The illustrated cyber security monitoring and mitigation system 10 can also include a model training and governance unit 100 for training the machine learning techniques employed by the system and for providing model governance of the techniques. The model governance helps establish the rules and controls for the machine learning techniques employed by the system, including access control, testing, validation, change and access logs, and the traceability of model results. Further, the model training can occur in the model training and governance unit 100 based on prior learning data sets as well as current data sets. The data sets can include if desired learning security data as well as real time security data. The unit 100 can also extract and/or determine selected types of data if desired, including performance metrics, model parameters, feature importance information, feature profile information, model files, LIME explanation related information, and the like.

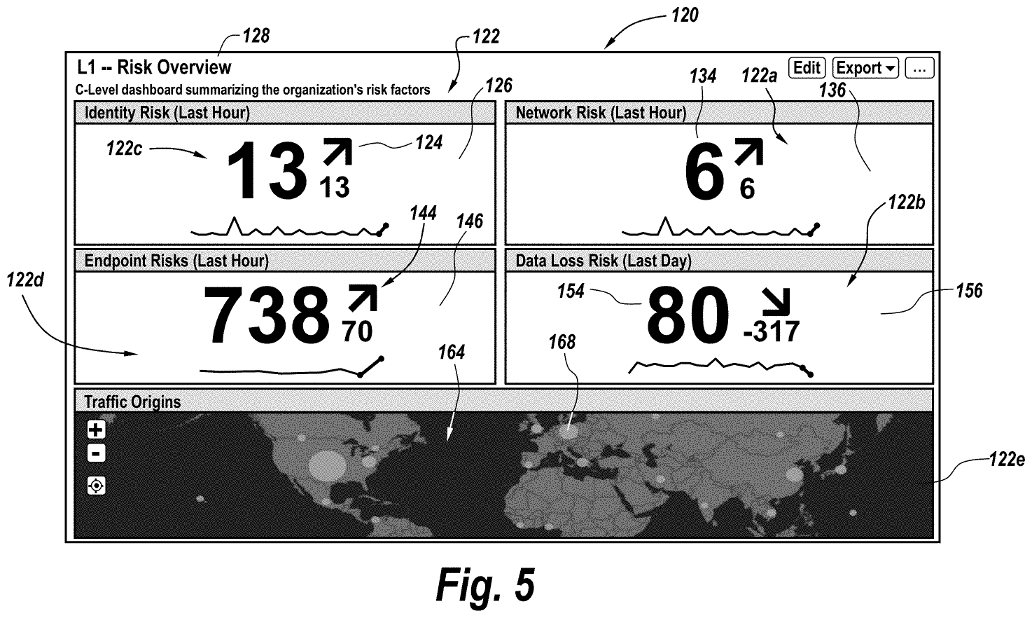

The fully processed security data and the associated prediction information generated by the model prediction unit 42 are conveyed to the results integrator unit 44. In the current example, the results integrator unit 44 can include a data visualization unit 110. The data visualization unit 110 can include any selected hardware and associated visualization software for generating reports or graphs for display on a suitable display device. The display device can form part of the system or can form part of an electronic or computer device that communicates with the system, as is known. The reports can be preselected or can be customized to present or display the processed security data and associated predictions in a suitable manner. The data visualization unit 110 can include any selected software application suitable for generating the reports and graphs, such as for example Splunk from Splunk Inc., USA. Examples of the reports or user interfaces that can be generated by the data visualization unit 110 are shown in FIGS. 5-7.

After the prediction data and the security data is received by the data visualization unit 110, the unit 110 or associated user interface unit can generate one or more selected reports or user interfaces. FIG. 5 illustrates a first selected user interface or window element 120 (herein generally referred to as a window, a frame or a page) generated by the data visualization unit 110 of the cyber security monitoring and mitigation system 10 of the present invention. The window element 120 can be structured to display on a suitable display device relevant information in any selected manner or format that is readily viewable and understandable to users in any selected capacity, such as for example users that are in leadership positions within the company. The illustrated window element 120 can include a header pane or ribbon 128 that is disposed or located at the topmost portion of the window element 120. The window element 120 can also include a series of pane elements 122, including a pair of stacked pane elements 122a and 122b formed along the right hand side of the window element 120, a pair of stacked pane elements 122c and 122d formed along the left hand side of the window element, and a bottom pane element 122e disposed beneath the bottommost one of the stacked left and right pane elements 122b, 122d, and which extends across the window element 120 from the left hand side thereof to the right hand side thereof. The window element 120 can have the header or title 128, such as the illustrated title or header L1-Risk Overview.

The left topmost pane element 122c can be configured as an Identity Risk pane element for illustrating through a graphical element 124 an identity risk score or value. Specifically, the risk score can be a unique monotonically increasing number that maps to the perceived or assigned risk for a specific machine, employee, contractor, vendor, customer, and electronic device (e.g., mobile phone, computer and the like), from being identified as a “known entity” to the institution. According to one practice, the Identity Risk pane element can be structured to cover a selected time increment or amount, such as for example one hour. Those of ordinary skill in the art will readily recognize that the time span or duration can be for any selected length of time. The graphical element 124 can be any desired graphical element that easily and readily displays the identity risk data to the user or observer. In the current example, the graphical element can take the form of a number set in or on a background 126. The number represents the extent to which the specific risk is of concern to the institution. The background 126 can be structured so as to display the security data in a visually distinctive manner that easily and readily imparts to the viewer the importance of the information in the pane element 122c. In the current example, a suitable color background can be employed to visually indicate the importance or risk profile of the information in the pane element.

The right top pane element 122a can be a Network Risk pane element illustrating through a graphical element 134 a network risk score or value. Specifically, the risk score can be a unique monotonically increasing number that maps to the perceived or assigned risk for a specific electronic device and the like from performing computer network traffic activity that seems improper to the institution. The network risk score indicates the overall risk to the network from cyber-attacks and the like. According to one practice, the Network Risk pane element can be structured to cover a selected time increment or amount, such as for example one hour. Those of ordinary skill in the art will readily recognize that the time span or duration can be for any selected length of time. The graphical element 134 can be any desired graphical element that easily and readily displays the network risk data to the user or observer. In the current example, the graphical element can take the form of a number set on a suitable background 136 that represents an example of a network threat. The background 136 can be structured so as to display the security data or associated score in a visually distinctive manner that easily and readily imparts to the viewer the importance of the information in the pane element 122a. In the current example, a suitable color background can be employed to visually indicate the importance or risk profile of the information in the pane element 122a.

The left bottom pane element 122d can be an Endpoint Risks pane element illustrating through a graphical element 144 an endpoint risk score or value. Specifically, the endpoint risk score can be a unique monotonically increasing number that maps to the perceived or assigned risk for a specific electronic device and the like, because the electronic device characteristics at a certain moment in time do not correlate with what is known within the system as being a predefined normal score. According to one practice, the Endpoint Risk pane element can be structured to cover a selected time increment or amount, such as for example one hour. Those of ordinary skill in the art will readily recognize that the time span or duration can be for any selected length of time. The graphical element 144 can be any desired graphical element that easily and readily displays the endpoint risk data to the user or observer. In the current example, the graphical element can take the form of a number set a background 146. The background 146 can also be structured so as to display the security data in a visually distinctive manner that easily and readily imparts to the viewer the importance of the information in the pane element 122d. In the current example, a suitable color background can be employed to visually indicate the importance or risk profile of the information in the pane element 122d.

The right bottom pane element 122b can be a Data Loss Risk pane element illustrating through a graphical element 154 a data loss risk score or value. Specifically, the data loss risk score can be a unique monotonically increasing number that maps to the perceived or assigned risk of actually losing, corrupting, or misusing enterprise, customer or employee data. The data loss risk indicates the likelihood that data can be lost based on real time cyber-attacks or threats to the system. According to one practice, the Data Loss Risk pane element can be structured to cover a selected time increment or amount, such as for example one day. Those of ordinary skill in the art will readily recognize that the time span or duration can be for any selected length of time. The graphical element 154 can be any desired graphical element that easily and readily displays the data loss risk data to the user or observer. In the current example, the graphical element can take the form of a number set a background 156. The background 156 can be structured so as to display the security data in a visually distinctive manner that easily and readily imparts to the viewer the importance of the information in the pane element 122b. In the current example, a suitable color background can be employed to visually indicate the importance or risk profile of the information in the pane element.

The bottommost pane element 122e can be a Traffic Origins pane element illustrating through a graphical element 164 the origins of the traffic on the network. The graphical element 164 can be any desired graphical element that easily and readily displays the identity risk data to the user or observer. In the current example, the graphical element can take the form of a world map that includes visual identifiers 168 identifying the location of the traffic on the network. The identifier can be sized so as to correspond to the volume of network traffic emanating from any of the identified locations. That is, the visual identifier can have a size that corresponds to the size of the data traffic emanating or originating in that region.

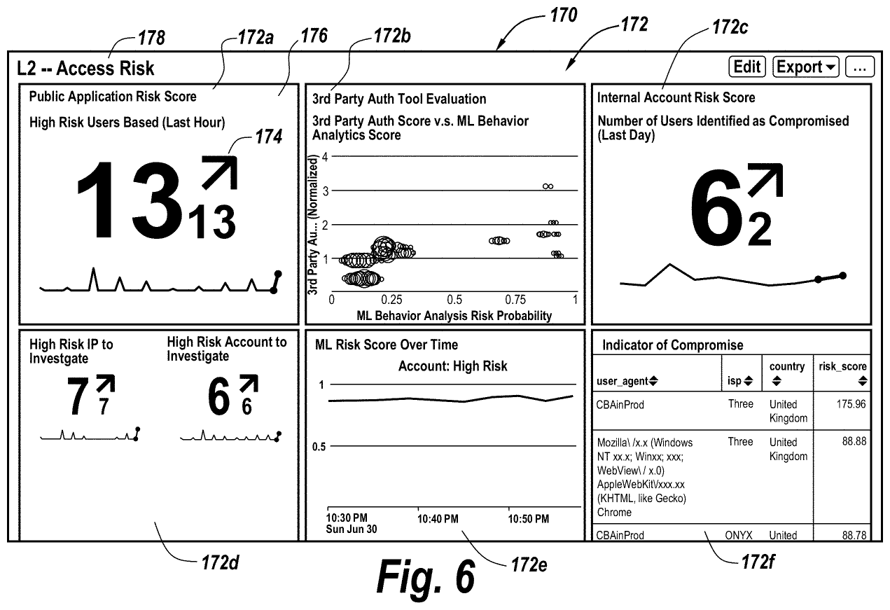

FIG. 6 illustrates a second selected user interface or window element 170 generated by the data visualization unit 110 of the cyber security monitoring and mitigation system 10 of the present invention. The window element 170 can be structured so as to display relevant information in any selected manner or format that is readily viewable and understandable to users in any selected capacity, such as for example users that are managing security applications within the company. The illustrated window element 170 displays the security data and the associated predictions in a selected format and in a selected manner. The window element 170 can include a pair of stacked rows of panes elements 172, such as pane elements 172a-172f that extend from left to right across the window element 170. The top row of panes includes pane elements 172a-172c and the bottom row of panes includes pane elements 172d-172f. The window element 170 can have a header or title pane or ribbon 178, such as the illustrated title or header L2-Access Risk. The information in the window element 170 is configured so as to display information suitable for review by mid-level management users, such as users who are managing the various software applications.

Similar to the pane elements 122 of FIG. 5, the pane elements 172 can have graphical elements and backgrounds associated therewith. The left top pane element 172a can be configured as a High Risk Users Based pane element for illustrating through a graphical element 174 a high risk user based score or value. According to one practice, the High Risk Users Based pane element can be structured to cover a selected time increment or amount, such as for example one hour. Those of ordinary skill in the art will readily recognize that the time span or duration can be for any selected length of time. The graphical element 174 can be any desired graphical element that easily and readily displays the risk data to the user or observer. In the current example, the graphical element 174 can take the form of a number set a background 176 that represent the number of threats on user login applications during the last hour, as well as the trend when compared to the previous hour data. The background 176 can be structured so as to visually display the security data in a visually distinctive manner that easily and readily imparts to the viewer the importance of the information in the pane element 172a. In the current example, a suitable color background can be employed to visually indicate the importance or risk profile of the information in the pane element. All of the pane elements 172 can employ graphical elements and backgrounds, and hence the details of such need not be further described herein.

The top middle pane element 172b can be configured as a Third Party Author Score pane element for illustrating through a graphical element a risk probability distribution. The system can employ suitable software application tools that obtain risk level information of each login and then assign each login an authorization score. To confirm that the score is effective in identifying threat and fraudulent activities in the system, the tool compares a behavioral based risk score with the authorization score. The right top pane element 172c can be configured as a Number of Users identified As Compromised pane element for illustrating through a graphical element the number of system users that are compromised. According to one practice, the pane element 172c can be structured to cover a selected time increment or amount, such as for example one day.

The left bottom pane element 172d can display multiple graphical elements related to High Risk IP to Investigate and High Risk Account to Investigate. The graphical elements can relate to the number of IP addresses to review so as to determine if they are compromised. The middle bottom pane element 172e can be configured as a High Risk Users Based pane element for illustrating through a graphical element a Machine Learning (ML) Risk Score Over Time pane element for illustrating a risk score generated by the model prediction unit 42 over time. According to one practice, the pane element 172e can be structured to cover any selected time increment or amount. The right bottom pane element 172f can be configured as an Indicator of Compromise pane element for illustrating through a graphical element an indicator of compromise data. The graphical element represents the two common scenarios of cyber threat to the system, including high risk IP addresses and High Risk accounts. The number represents the cases the analysts need to investigate on these two threat scenarios.

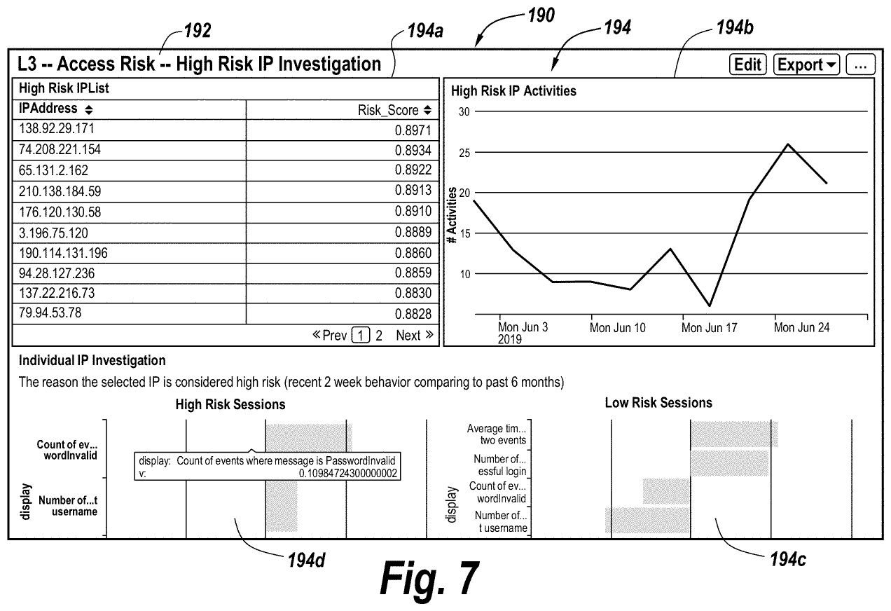

FIG. 7 illustrates a third selected user interface or window element 190 that can be generated by the data visualization unit 110 of the cyber security monitoring and mitigation system 10 of the present invention. The window element 190 can be structured to display on a suitable display device relevant information in any selected manner or format that is readily viewable and understandable to users in any selected capacity, such as for example users that are working directly the software applications of the system. The illustrated window element 190 can include a header pane or ribbon 192 that is disposed or located at the topmost portion of the window element 190. The window element 190 can also include a first upper row of pane elements 194a and 194b and a lower pane elements 194c. The lower pane element 194c extends from across the width of the window element. The upper left pane element 194a can be configured as a High Risk IP List pane element that includes one or more first graphical elements that sets forth IP addresses of users on the network that may be at risk, as well as one or more second graphical elements that list an associated risk score that can be generated by the cyber security monitoring and mitigation system 10. The right upper pane element 194b can be configured as a High Risk IP Activities pane element that sets forth information concerning the network activity of Ip addresses that the system denotes as possibly being high risk for attack or which have been attacked. The pane element 194b can include a graphical element configured as a graph that graphically illustrates the activity of the IP address relative to time.

The illustrated window element 190 also includes a lower pane element 194C that can be configured as an Individual IP Investigation pane element that can include graphical elements that illustrate the number of high risk sessions of one or more users as well as the number of low risk sessions.

### Exemplary Hardware

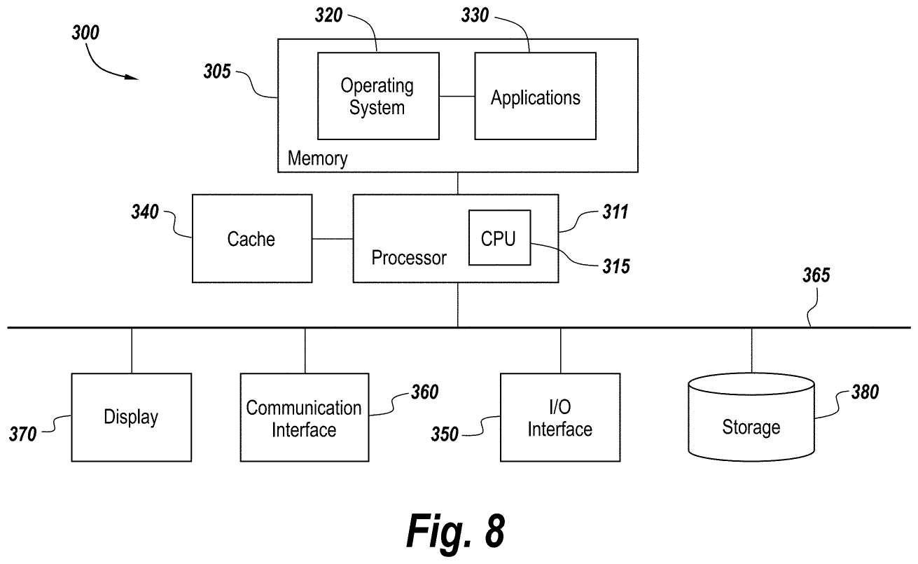

It should be appreciated that the various concepts, methods, and systems introduced above and discussed below may be implemented in any number of ways, as the disclosed concepts are not limited to any particular manner of implementation or system configuration. Examples of specific implementations and applications are provided below primarily for illustrative purposes and for providing or describing the operating environment and associated hardware of the cyber security monitoring and mitigation system 10 of the present invention. The cyber security monitoring and mitigation system 10 of the present invention can employ a plurality of electronic devices, such as one or more servers, clients, computers and the like, that are networked together or which are arranged so as to effectively communicate with each other. Specifically, one or more of the aforementioned data processing unit 32 including the data profiler unit 60 and the data cleaner unit 70, the data connector unit 30, the data merger unit 34, the AI module 38, the model deployment unit 40, the model prediction unit, and results integrator unit 44, can be implemented in software, hardware, or a combination of both, and preferably one or more of the units can be implemented via one or more electronic devices employing suitable software applications to perform the functions associated with that device. The network 14 can be any type or form of network. The electronic devices can be on the same network or on different networks. In some embodiments, the network system may include multiple, logically-grouped servers. In one of these embodiments, the logical group of servers may be referred to as a server farm or a machine farm. In another of these embodiments, the servers may be geographically dispersed. The electronic devices can communicate through wired connections or through wireless connections. The clients can also be generally referred to as local machines, clients, client nodes, client machines, client computers, client devices, endpoints, or endpoint nodes. The servers can also be referred to herein as servers, nodes, or remote machines. In some embodiments, a client has the capacity to function as both a client or client node seeking access to resources provided by a server or node and as a server providing access to hosted resources for other clients. The clients can be any suitable electronic or computing device, including for example, a computer, a server, a smartphone, a smart electronic pad, a portable computer, and the like, such as the electronic device 300 illustrated in FIG. 8. Further, the server may be a file server, application server, web server, proxy server, appliance, network appliance, gateway, gateway server, virtualization server, deployment server, SSL VPN server, or firewall, or any other suitable electronic or computing or computer device, such as the electronic device 300. In one embodiment, the server may be referred to as a remote machine or a node. In another embodiment, a plurality of nodes may be in the path between any two communicating servers or clients. The system 10, the financial data processing unit 22, and/or the security layer 24 of the present invention can be stored on one or more of the clients, servers, and the hardware associated with the client or server, such as the processor or CPU and memory described below.

FIG. 8 is a high-level block diagram schematic depiction of an electronic device 300 that can be used with the embodiments disclosed herein. As noted any of the units of the cyber security monitoring and mitigation system 10 can be implemented using one or more of the electronic devices 300. Without limitation, the hardware, software, and techniques described herein can be implemented in digital electronic circuitry or in computer hardware that executes firmware, software, or combinations thereof. The implementation can be as a computer program product (e.g., a non-transitory computer program tangibly embodied in a machine-readable storage device, for execution by, or to control the operation of, one or more data processing apparatuses, such as a programmable processor, one or more computers, one or more servers and the like).

The illustrated electronic device 300 can include any suitable electronic circuitry that includes a main memory unit 305 that is connected to a processor 311 having a CPU 315 and a cache unit 340 configured to store copies of the data from the most frequently used main memory 305.

Further, the methods and procedures for carrying out the methods disclosed herein can be performed by one or more programmable processors executing a computer program to perform the functions, operations, and methods of the present invention by operating on input data and generating output data. Further, the methods and procedures disclosed herein can also be performed by, and the apparatus disclosed herein can be implemented as, special purpose logic circuitry, such as a FPGA (field programmable gate array) or an ASIC (application specific integrated circuit). Modules and units disclosed herein can also refer to portions of the computer program and/or the processor/special circuitry that implements that functionality.

The processor 311 can be any logic circuitry that responds to, processes or manipulates instructions received from the main memory unit, and can be any suitable processor for execution of a computer program. For example, the processor 311 can be a general and/or special purpose microprocessor and/or a processor of a digital computer. The CPU 315 can be any suitable processing unit known in the art. For example, the CPU 315 can be a general and/or special purpose microprocessor, such as an application-specific instruction set processor, graphics processing unit, physics processing unit, digital signal processor, image processor, coprocessor, floating-point processor, network processor, and/or any other suitable processor that can be used in a digital computing circuitry. Alternatively or additionally, the processor can comprise at least one of a multi-core processor and a front-end processor. Generally, the processor 311 can be embodied in any suitable manner. For example, the processor 311 can be embodied as various processing means such as a microprocessor or other processing element, a coprocessor, a controller or various other computing or processing devices including integrated circuits such as, for example, an ASIC (application specific integrated circuit), an FPGA (field programmable gate array), a hardware accelerator, or the like. Additionally or alternatively, the processor 311 can be configured to execute instructions stored in the memory 305 or otherwise accessible to the processor 311. As such, whether configured by hardware or software methods, or by a combination thereof, the processor 311 can represent an entity (e.g., physically embodied in circuitry) capable of performing operations according to embodiments disclosed herein while configured accordingly. Thus, for example, when the processor 311 is embodied as an ASIC, FPGA or the like, the processor 311 can be specifically configured hardware for conducting the operations described herein. Alternatively, as another example, when the processor 311 is embodied as an executor of software instructions, the instructions can specifically configure the processor 311 to perform the operations described herein. In many embodiments, the central processing unit 530 is provided by a microprocessor unit, e.g.: those manufactured by Intel Corporation of Mountain View, Calif.; those manufactured by Motorola Corporation of Schaumburg, Ill.; the ARM processor and TEGRA system on a chip (SoC) manufactured by Nvidia of Santa Clara, Calif; the POWER7 processor, those manufactured by International Business Machines of White Plains, N.Y.; or those manufactured by Advanced Micro Devices of Sunnyvale, Calif. The processor can be configured to receive and execute instructions received from the main memory 305.

The illustrated electronic device 300 applicable to the hardware of the present invention can be based on any of these processors, or any other processor capable of operating as described herein. The central processing unit 315 may utilize instruction level parallelism, thread level parallelism, different levels of cache, and multi-core processors. A multi-core processor may include two or more processing units on a single computing component. Examples of multi-core processors include the AMD PHENOM IIX2, INTEL CORE i5 and INTEL CORE i7.

The processor 311 and the CPU 315 can be configured to receive instructions and data from the main memory 305 (e.g., a read-only memory or a random access memory or both) and execute the instructions. The instructions and other data can be stored in the main memory 305. The processor 311 and the main memory 305 can be included in or supplemented by special purpose logic circuitry. The main memory unit 305 can include one or more memory chips capable of storing data and allowing any storage location to be directly accessed by the processor 311. The main memory unit 305 may be volatile and faster than other memory in the electronic device, or can dynamic random access memory (DRAM) or any variants, including static random access memory (SRAM), Burst SRAM or SynchBurst SRAM (BSRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Single Data Rate Synchronous DRAM (SDR SDRAM), Double Data Rate SDRAM (DDR SDRAM), Direct Rambus DRAM (DRDRAM), or Extreme Data Rate DRAM (XDR DRAM). In some embodiments, the main memory 305 may be non-volatile; e.g., non-volatile read access memory (NVRAM), flash memory non-volatile static RAM (nvSRAM), Ferroelectric RAM (FeRAM), Magnetoresistive RAM (MRAM), Phase-change memory (PRAM), conductive-bridging RAM (CBRAM), Silicon-Oxide-Nitride-Oxide-Silicon (SONOS), Resistive RAM (RRAM), Racetrack, Nano-RAM (NRAM), or Millipede memory. The main memory 305 can be based on any of the above described memory chips, or any other available memory chips capable of operating as described herein. The main memory can be configured to communicate with other system memory, including without limitation the storage elements 20, 22.

In the embodiment shown in FIG. 8, the processor 311 communicates with main memory 305 via a system bus 365. The computer executable instructions of the present invention may be provided using any computer-readable media that is accessible by the computing or electronic device 300. As such, the processor can be suitably programmed to execute instructions to perform the various functions and methods of the units of the present invention. Computer-readable media may include, for example, the computer memory or storage unit 305. The computer storage media may also include, but is not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or other data in a modulated data signal, such as a carrier wave, or other transport mechanism. As defined herein, computer readable storage media does not include communication media. Therefore, a computer storage or memory medium should not be interpreted to be a propagating signal per se or stated another transitory in nature. The propagated signals may be present in a computer storage media, but propagated signals per se are not examples of computer storage media, which is intended to be non-transitory. Although the computer memory or storage unit 305 is shown within the computing device 300 it will be appreciated that the storage may be distributed or located remotely and accessed via a network or other communication link.

The main memory 305 can comprise an operating system 320 that is configured to implement various operating system functions. For example, the operating system 320 can be responsible for controlling access to various devices, memory management, and/or implementing various functions of the asset management system disclosed herein. Generally, the operating system 320 can be any suitable system software that can manage computer hardware and software resources and provide common services for computer programs.

The main memory 305 can also hold suitable application software 330. For example, the main memory 305 and application software 330 can include various computer executable instructions, application software, and data structures, such as computer executable instructions and data structures that implement various aspects of the embodiments described herein. For example, the main memory 305 and application software 330 can include computer executable instructions, application software, and data structures, such as computer executable instructions and data structures that implement various aspects of the content characterization systems disclosed herein, such as processing and capture of information. Generally, the functions performed by the content characterization systems disclosed herein can be implemented in digital electronic circuitry or in computer hardware that executes software, firmware, or combinations thereof. The implementation can be as a computer program product (e.g., a computer program tangibly embodied in a non-transitory machine-readable storage device) for execution by or to control the operation of a data processing apparatus (e.g., a computer, a programmable processor, or multiple computers). Generally, the program codes that can be used with the embodiments disclosed herein can be implemented and written in any form of programming language, including compiled or interpreted languages, and can be deployed in any form, including as a stand-alone program or as a component, module, subroutine, or other unit suitable for use in a computing environment. A computer program can be configured to be executed on a computer, or on multiple computers, at one site or distributed across multiple sites and interconnected by a communications network, such as the Internet.

The processor 311 can further be coupled to a database or data storage 380. The data storage 380 can be configured to store information and data relating to various functions and operations of the content characterization systems disclosed herein. For example, as detailed above, the data storage 380 can store information including but not limited to captured information, multimedia, processed information, and characterized content.

A wide variety of I/O devices may be present in or connected to the electronic device 300. For example, the device can include a display 370. The display 370 can be configured to display information and instructions received from the processor 311. Further, the display 370 can generally be any suitable display available in the art, for example a Liquid Crystal Display (LCD), a light emitting diode (LED) display, digital light processing (DLP) displays, liquid crystal on silicon (LCOS) displays, organic light-emitting diode (OLED) displays, active-matrix organic light-emitting diode (AMOLED) displays, liquid crystal laser displays, time-multiplexed optical shutter (TMOS) displays, or 3D displays, or electronic papers (e-ink) displays. Furthermore, the display 370 can be a smart and/or touch sensitive display that can receive instructions from a user and forwarded the received information to the processor 311. The display can be associated with one or more of the system units, such as the results integrator unit 44, and can be employed to display the user interfaces set forth in FIGS. 5-7. The electronic device can include other input devices such as keyboards, mice, trackpads, trackballs, touchpads, touch mice, multi-touch touchpads and touch mice, microphones, multi-array microphones, drawing tablets, cameras, single-lens reflex camera (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. The output devices can also include video displays, graphical displays, speakers, headphones, inkjet printers, laser printers, and 3D printers.

The electronic device 300 can also include an Input/Output (I/O) interface 350 that is configured to connect the processor 311 to various interfaces via an input/output (I/O) device interface 380. The device 300 can also include a communications interface 360 that is responsible for providing the circuitry 300 with a connection to a communications network (e.g., communications network 120). Transmission and reception of data and instructions can occur over the communications network.

It will thus be seen that the invention efficiently attains the objects set forth above, among those made apparent from the preceding description. Since certain changes may be made in the above constructions without departing from the scope of the invention, it is intended that all matter contained in the above description or shown in the accompanying drawings be interpreted as illustrative and not in a limiting sense.

It is also to be understood that the following claims are to cover all generic and specific features of the invention described herein, and all statements of the scope of the invention which, as a matter of language, might be said to fall therebetween.

Having described the invention, what is claimed as new and desired to be secured by Letters Patent is:

We claim

1. A cyber security monitoring and mitigation system, comprising
one or more data sources for storing or generating security data,
a deployment infrastructure subsystem having a security tool layer for generating at least a portion of the security data and one or more storage elements for storing at least a portion of the security data,
a data analytics module for processing the security data, wherein the analytics module includes
a data connector unit for collecting the security data from one or more of the data sources, parsing the data, and then organizing the security data into a selected format a data frame to form organized security data, wherein each portion of the security data in the organized security data has values associated therewith,
a data preprocessing unit for profiling and correcting the organized security data in the data frame to form cleaned security data,
a data merger unit for merging the cleaned security data from two or more of the plurality of data sources to form merged security data,
a cyber feature unit for identifying based on preselected cyber features selected portions of the merged security data associated with the cyber features,
a model development unit for applying one or more selected machine learning techniques to the cleaned security data based on the preselected cyber features to the features from the cyber feature unit to form output model data, and
a model prediction unit for generating based on the output model data one or more prediction values based on the cleaned security data and the cyber features, and
a results integrator unit for generating from the prediction values one or more user interfaces for displaying the prediction values,
wherein the data connector unit generates a data frame containing therein the organized security data, and
wherein the data preprocessing unit includes
a data profiler unit that is configured to analyze and to process the organized security data in the data frame received from the data connector unit and to summarize one or more the values associated with the security data portions in the organized security data contained in the data frame by extracting statistical value data associated therewith to form profiled security data, and
a data cleaner unit for applying a uniform cleaning schema to the profiled security data and for detecting and correcting inaccurate or incomplete information in the profiled security data within the data frame to form the cleaned security data, wherein the uniform cleaning schema is a two-dimensional data structure:

2. The system of claim 1, further comprising a network for communicating with the one or more of the one or more data sources, the data analytics module, and the deployment infrastructure, and for communicating the security data therebetween.

3. The system of claim 1, further comprising a data search engine communicating with the data connector unit and the security data for searching the security data for one or more selected parameters.

4. The system of claim 1, wherein one or more values associated with the organized data comprises selected numerical fields, timestamp information, categorical field information, information related to changes in the security data, and historical trend information.

5. The system of claim 4, wherein cleaned security data includes data sets and wherein the merger unit is configured to tag the data sources so as to correctly identify the sources and to normalize the data sets.

6. The system of claim 5, wherein the cyber feature unit comprises a plurality of selectable cyber features, wherein the cyber features are generated using the cleaned security data to identify selected patterns in the cleaned security data and the source data.

7. The system of claim 1, wherein the machine learning technique of the model deployment unit comprises one or more of a supervised machine learning technique, an unsupervised machine learning technique, a semi-supervised learning technique, a self-learning technique, or a reinforcement machine learning technique.

8. The system of claim 1, further comprising an artificial intelligence (AI) module for applying one or more machine learning techniques to the security data.

9. The system of claim 8, wherein the artificial intelligence module comprises a model training and governance module for performing training on the machine learning technique.

10. The system of claim 1, wherein the data profiler unit is configured for summarizing a value of a plurality of parameters associated with the data frame by extracting statistical information associated with the security data.

11. The system of claim 10, wherein the cleaning schema of the data cleaner unit is a two-dimensional data structure that analyzes and cleans the profiled security data by ensuring that values in the data structure are correct and by interpolating any missing values.

12. A computer implemented method, comprising
providing security data from one or more data sources,
generating at least a portion of the security data and storing at least a portion of the security data in one or more storage elements,
processing the security data by:
collecting the security data from one or more of the data sources, parsing the data, and then organizing the security data into a selected format to form organized security data and generating a data frame containing therein the organized security data, wherein each portion of the security data in the organized security data has values associated therewith,
preprocessing the organized security data by profiling and correcting the organized security data in the data frame to form cleaned security data by
analyzing and processing the organized security data in the data frame and summarizing one or more the values associated with the organized security data contained in the data frame by extracting statistical value data associated therewith to form profiled security data, and
applying a uniform cleaning schema to the profiled security data and detecting and correcting inaccurate or incomplete information in the profiled security data within the data frame to form the cleaned security data, wherein the uniform cleaning schema is a two-dimensional data structure,
merging the cleaned security data from two or more of the plurality of data sources to form merged security data,
identifying based on one or more preselected cyber features selected portions of the merged security data associated with the cyber features,
applying one or more selected machine learning techniques to the cleaned security data based on the preselected cyber features to the cleaned security data to form output model data, and
generating based on the output model data one or more prediction values based on the cleaned security data and the cyber features, and
generating from the prediction values one or more user interfaces for displaying the prediction values.

13. The computer implemented method of claim 12, further comprising providing a data search engine for searching the security data for one or more selected parameters.

14. The computer implemented method of claim 12, wherein one or more values associated with the organized data comprises selected numerical fields, timestamp information, categorical field information, information related to changes in the security data, and historical trend information, and the method further comprising generating the cyber features using the cleaned security data to identify selected patterns in the cleaned security data and in the source data.

15. The computer-implemented method of claim 12, wherein step of analyzing and processing the organized security data comprises summarizing a value of a plurality of parameters associated with the data frame by extracting statistical information associated with the security data.

16. The computer-implemented method of claim 15, wherein the cleaning schema of the data cleaner unit is a two-dimensional data structure that analyzes and cleans the profiled security data by ensuring that values in the data structure are correct and by interpolating any missing values.
